(19) United States
(12) Patent Application Publication
(10) Pub. No.: US 2010/0164856 A1
(43) Pub. Date: Jul. 1, 2010

(54) FIELD SEQUENTIAL DISPLAY WITH OVERLAPPED MULTI-SCAN DRIVING AND METHOD THEREOF

(76) Inventors: Jhen-Shen Liao, Taoyuan County (TW); Yi-Nan Chu, Changhua County (TW)

Correspondence Address: NORTH AMERICA INTELLECTUAL PROPERTY CORPORATION, P.O. BOX 506, MERRIFIELD, VA, 22116, US

(21) Appl. No.: 12/408,718

(22) Filed: Mar. 22, 2009

(30) Foreign Application Priority Data
Dec. 31, 2008 (TW) 097151613

(51) Int. Cl. G09G 3/36; G09G 5/10

(52) U.S. Cl. 345/102; 345/690

(57) ABSTRACT

A field sequential display method with overlapped multi-scan driving applied in a Field Sequential Display and device thereof includes turning on LEDs of one color in each of a plurality of blocks of a backlight module sequentially, and writing the image data of the color into pixels of the block when the LEDs of the color of the block are turned on; writing a voltage of a black frame into the pixels of the block after the image data of the color is written into the pixels of the block; and turning off the LEDs of one color of the block after the voltage of the black frame is written into the pixels of the block. By doing so, the response time of a crystal of a pixel can be increased, and uneven color distribution in the upper and lower portions of the frame can be reduced.

### BACKGROUND OF THE INVENTION

1. Field of the Invention

The present invention relates to a Field Sequential Display (FSD) method with overlapped multi-scan driving applied in an FSD and the device thereof, and more particularly, to an FSD method with overlapped multi-scan driving applied in an FSD and the device thereof utilizing the black frame insertion to reduce the motion blur of a display panel.

2. Description of the Prior Art

Color mixture for displays can be categorized into two types: timing color mixture and spatial color mixture. The timing color mixture achieves color mixing by passing one of RGB light sources according to the corresponding time-slice, e.g. the color sequential method, which utilizes the photogene of the human naked eyes to confuse the human visual system for color mixing. The spatial color mixture comprises, for example, the color concurrent method and the strip alignment method.

Please refer to FIG. 1. FIG. 1 is a diagram illustrating the conventional strip alignment method, the color concurrent method and the color sequential method. In the prior art, the strip alignment method, which utilizes the color filters, is the mainstream of the color mixture. Taking a TFT-LCD (Thin Field Transistor Liquid Crystal Display) as an example, every pixel comprises three sub-pixels, which one displays color red by the color filter, another one displays color green by the color filter, and the other displays color blue by the color filter. The sizes of these sub-pixels are smaller than the perception scope of the human eyes, allowing the human visual system to perceive the final color after being mixed. However, the color sequential method of timing color mixture, is gradually gaining popularity. Compare to the strip alignment method, the color sequential method have the following advantages: 1. high resolution; 2. requires less number of driving ICs; 3. carries the ability of color balancing adjustment; 4. does not require the color filter, which simplifies the composition of the liquid crystal cell and saves the overall space. Additionally, the display device employing the color sequential method is called FSD.

Please refer to FIG. 2. FIG. 2 is a block diagram illustrating a conventional FSD 10. The FSD 10 comprises a video source 12, a color sequence controller 14, a memory 16, a display panel module 18, and a backlight module 20. As shown in FIG. 2, the parallel RGB signal and the control signal are inputted from the video source 12 to the color sequence controller 14. The color sequence controller 14 comprises two I/O (input/output) buffers F1 and F2, a data stream converter 141, and a memory control unit 143. The I/O buffer F1 is utilized to receive the input signals, such as the parallel RGB signal and the control signal, from the video source 12. The data stream converter 141 is utilized to convert the parallel RGB signal to the serial RGB signal. The I/O buffer F2 is utilized to output the serial RGB signal transmitted from the data stream converter 141. The memory control unit 143 is utilized to transmit/receive the signals to/from the memory 16. Subsequently, the I/O buffer F2 outputs the serial RGB signal transmitted from the data stream converter 141 to the display panel module 18, as well as outputting the driving signal of the color sequential method to the backlight module 20. When the I/O buffer F2 outputs the driving signal to the backlight module 20, the color sequence controller 14 synchronously controls the backlight module 20 to turn on the corresponding Light Emitting Diode (LED) of the backlight module 20, for displaying the desired RGB signal.

Please refer to FIG. 3. FIG. 3 is a timing diagram illustrating the relation between signals of the backlight module 20 and the display panel module 18 of the conventional FSD. The color sequence of the frame data being written in the display panel module 18 is: red, green, and blue. That is, after the writing of the red frame data of one frame completes, the writing of the green frame data of that frame starts to write, and after the writing of the green frame data of that frame completes, the writing of the blue frame data of that frame starts to write. As shown in FIG. 3, after the red frame data of a frame is written in completely, the corresponding red LEDs of the backlight module 20 are turned on accordingly; after the green frame data of the frame is written in completely, the corresponding green LEDs of the backlight module 20 are turned on accordingly; after the blue frame data of the frame is written in completely, the corresponding blue LEDs of the backlight module 20 are turned on accordingly. Furthermore, after one color frame data is written in the corresponding sub-pixel completely, the liquid crystal corresponding to the sub-pixel carries that color frame data. However, if the LEDs corresponding to one color are turned before the writing of the frame data of that color of a current frame is completed, the interference is caused since the liquid crystal of the corresponding LEDs still carries frame data of that color of a frame previous to the current frame.

Because updating a frame requires scanning the scan lines of the display panel module 18 from top to bottom, resulting in a time difference between updating the scan lines at the top region and the scan lines at the bottom region of the frame since scanning time of total scan lines is limited by the frame rate. In other words, the scanning times of the first couple of scan lines and the last couple of scan lines are different, i.e. the periods for the image data writing in the sub-pixels of the last couple of scan lines are shorter. As mentioned above, the LEDs in the backlight module 20 can only be turned on after the frame data of the corresponding color are completely written in. Therefore LEDs corresponding to the last couple of scan lines have such relatively short time that results in the lack of response time for the corresponding liquid crystals. Consequently the corresponding liquid crystals fail to reach the desired brightness, causing uneven color distribution between the top region and the bottom region of the display area.

Furthermore, increasing the write-in frequency of the color sequential method also causes insufficient charging time for the liquid crystal, consequently degrading the overall display quality. Please refer to FIG. 4. FIG. 4 is a waveform diagram illustrating the insufficient charging time of the liquid crystals during the polarity inversion of different color fields. As shown in FIG. 4, when the color fields of a frame execute polarity inversion (dot inversion), the insufficient charging time of the fields may result in contrast deficiency of the displayed frame.

During dot inversion for frames, if the field for one of RGB colors is charged insufficiently, which means the corresponding liquid crystal area of the color field cannot turn off the light of the color field, causing color shift, as shown in FIG. 5. Furthermore, if the insufficient charging time for the corresponding liquid crystal area is considered to improve the problem of color shift, the on-times of the corresponding LEDs are reduced, causing the luminance is reduced as well. In this way, number of the corresponding LEDs has to be increased for generating luminance as the original luminance. Therefore, in the prior art, there is no solution to solve color shift without increasing the number of the LEDs in the FSD, which is great inconvenience.

### SUMMARY OF THE INVENTION

The present invention provides a Field Sequential Display (FSD) with overlapped multi-scan driving. The FSD comprises a Thin Film Transistor (TFT) Liquid Crystal Display (LCD) display panel module, comprising a pixel array, the pixel array comprising a plurality of pixels, each pixel comprising a pixel control switch, comprising a gate and a source; and a black insertion control switch, comprising a gate; a backlight module, comprising a plurality of red Light Emitting Diodes (LED), a plurality of green LEDs, and a plurality of blue LEDs; and a field sequence controller, comprising a timing control unit, electrically connected to the gate of the pixel control switch through a gate signal line, and electrically connected to the gate of the black insertion control switch through a black insertion signal line, for turning on/off the pixel control switch and the black insertion control switch; an Input/Output (I/O) buffer, electrically connected to the source of the pixel control switch through a data signal line, for transmitting data signals to the pixel; and a backlight module control unit, electrically connected to the plurality of the red LEDs, the plurality of the green LEDs, and the plurality of the blue LEDs, for turning on/off the plurality of the red LEDs, the plurality of the green LEDs, and the plurality of the blue LEDs.

The present invention further provides a display method for FSD with overlapped multi-scan driving. The display method comprises turning on LEDs for one color of a first block of a plurality of blocks of a backlight module; writing a first frame data for the color to pixels of the first block when the LEDs for the color of the first block are turned on; turning on LEDs for the color of a second block of the plurality of the blocks after the first frame data for the color is written to storage capacitors of the pixels of the first block; wherein the second block is adjacent to the first block; writing a second frame data for the color to pixels of the second block when the LEDs for the color of the second block are turned on; writing a black insertion voltage level to the pixels of the first block after the first frame data is written to liquid crystal capacitors of the pixels of the first block; and turning off the LEDs for the color of the first block after the black insertion voltage level is written to the pixels of the first block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the conventional strip alignment method, the color concurrent method and the color sequential method.

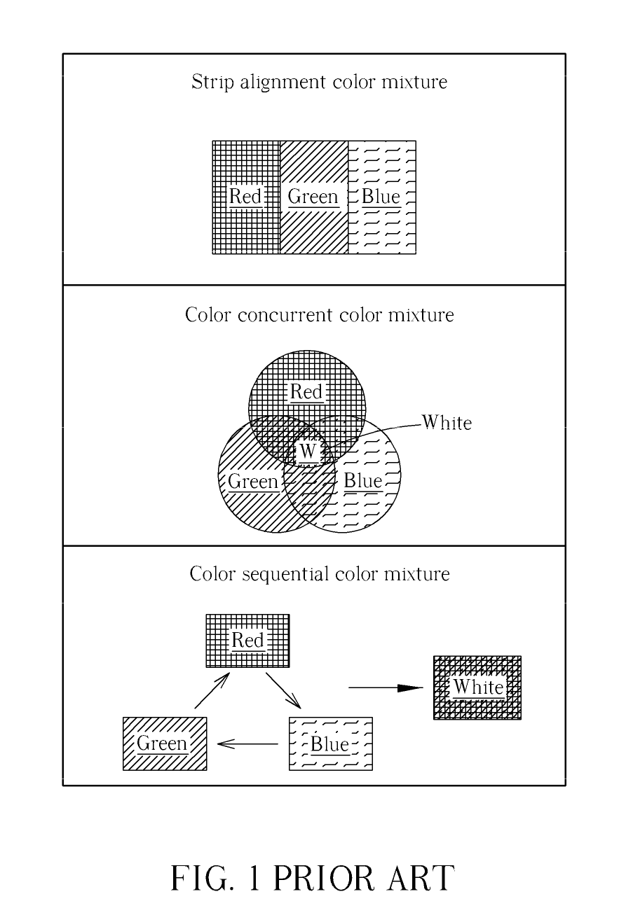

FIG. 2 is a block diagram illustrating a conventional FSD.

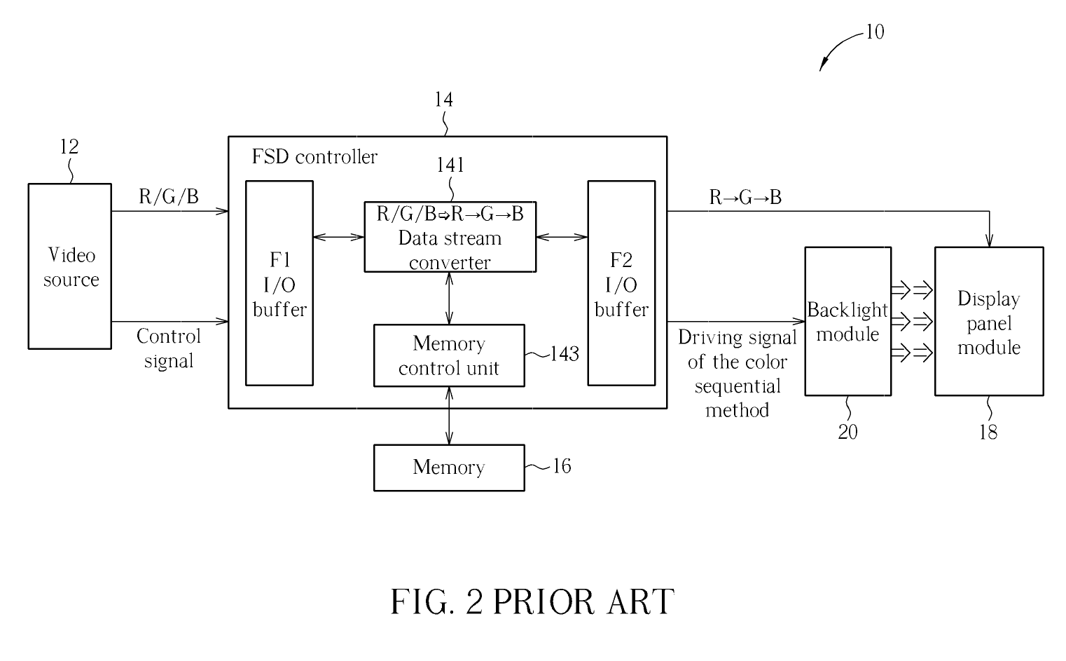

FIG. 3 is a timing diagram illustrating the relation between signals of the backlight module and the display panel module of the conventional FSD.

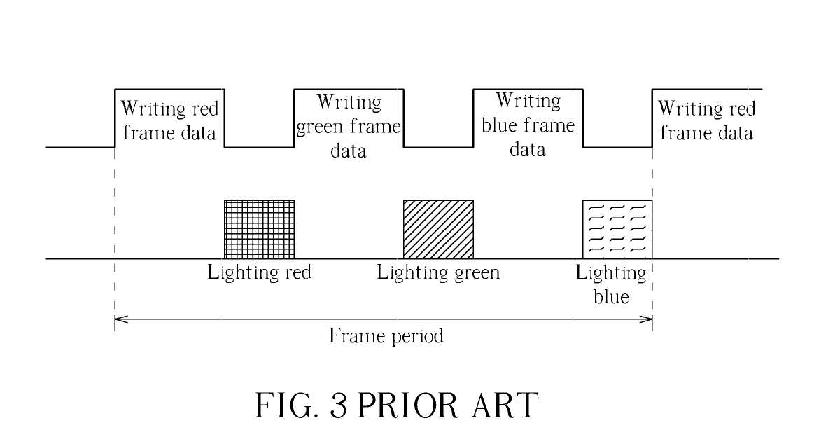

FIG. 4 is a waveform diagram illustrating the insufficient charging time of the liquid crystals during the polarity inversion of different color fields.

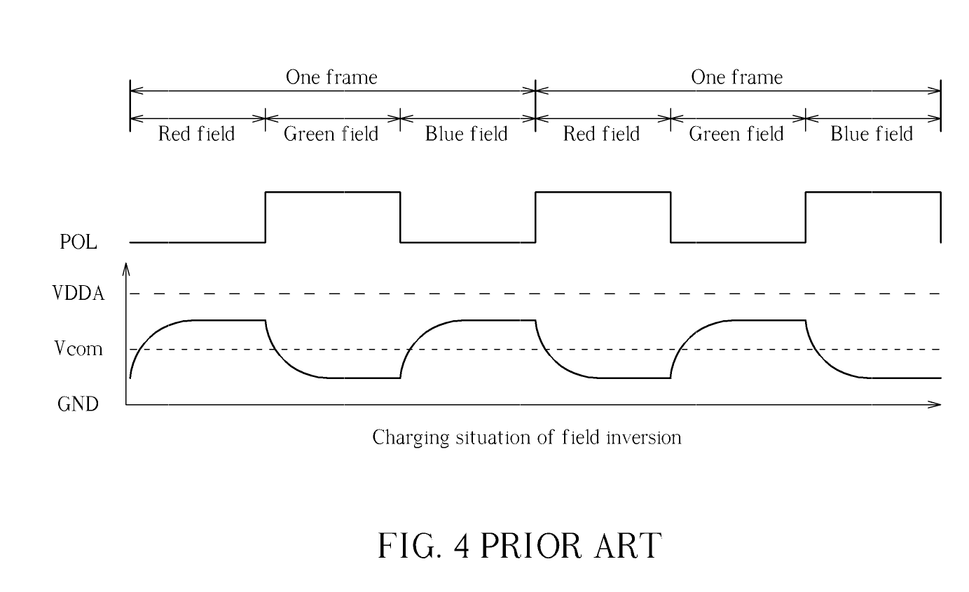

FIG. 5 is a waveform diagram illustrating the insufficient charging time of the liquid crystals caused by increasing of the writing frequency.

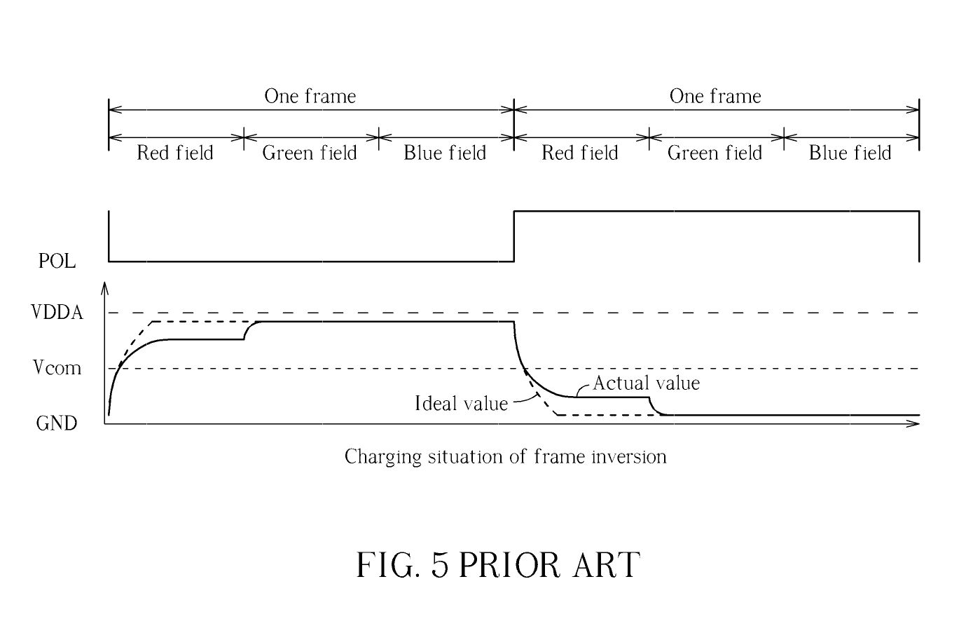

FIG. 6 is a block diagram illustrating an FSD with overlapped multi-scan driving according to an embodiment of the present invention.

FIG. 7 is a circuit diagram illustrating a pixel of the display panel module of the FSD of the present invention.

FIG. 8 is a block diagram illustrating a display panel module with overlapped multi-scan driving by dot inversion according to the present invention.

FIG. 9 is diagram illustrating the wire layout of the display panel of the display panel module according to the present invention.

FIG. 10 is a flowchart illustrating a display method according to an embodiment of the FSD with overlapped multi-scan driving of the present invention.

FIG. 11 is a diagram illustrating the driving principles of the FSD with overlapped multi-scan driving according to the present invention.

FIG. 12 is a diagram illustrating one frame including four fields according the FSD with overlapped multi-scan driving of the present invention.

FIG. 13 is a diagram illustrating transition of the liquid crystal according to the FSD with overlapped multi-scan driving of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “electrically connect” is intended to mean either an indirect or direct electrical connection. Accordingly, if one device is coupled to another device, that connection may be through a direct electrical connection, or through an indirect electrical connection via other devices and connections.

With the drawback of the conventional technology in mind, the present invention provides a black insertion technology, which adds a black insertion control switch to each pixel of the FSD panel module in order to eliminate the residual color data of a previous frame, and dividing the LEDs of the backlight module into a plurality of areas, turning on the plurality of the areas of the LEDs overlappingly for prolonging on-times of the LEDs, so as to solve the insufficient charging time for the liquid crystal and the reduction of the on-times of the LEDs, caused by the increasing of the refreshing frequency of field sequential method.

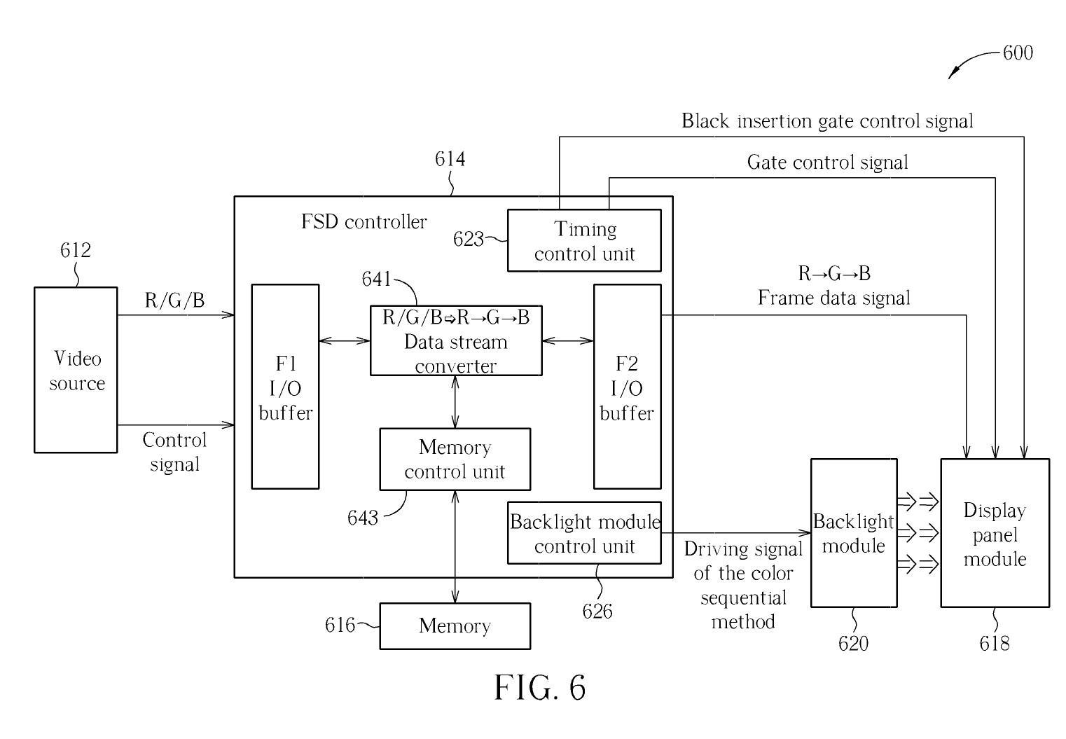

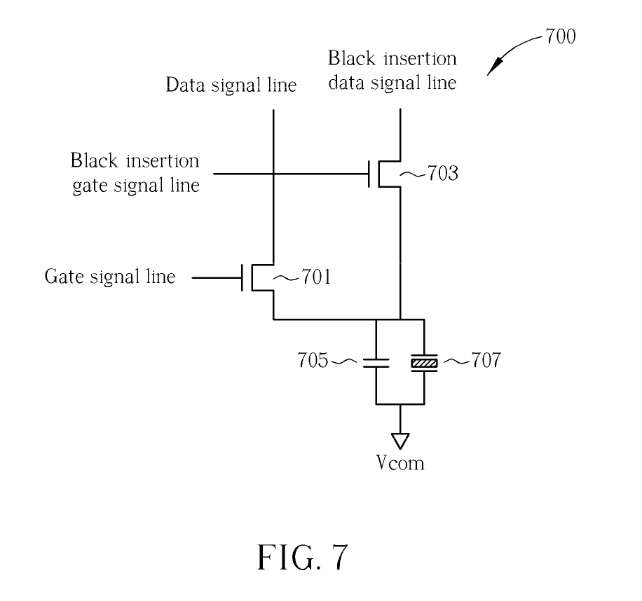

Please refer to FIG. 6 and FIG. 7. FIG. 6 is a block diagram illustrating an FSD 600 with overlapped multi-scan driving according to an embodiment of the present invention. FIG. 7 is a circuit diagram illustrating a pixel 700 of the display panel module of the FSD 600 of the present invention. The FSD 600 comprises a video source 612, a field sequence controller 614, a memory 616, a display panel module 618, and a backlight module 620. As shown in FIG. 6, the parallel video signal RGB and the control signal are inputted to the field sequence controller 614 through the video source 612. The field sequence controller 614 comprises I/O buffers F1 and F2, a data stream converter 641, and a memory control unit 643. The I/O buffer F1 receives signals transmitted from the video source 612, e.g. the parallel video signal RGB and the control signal. The data stream converter 641 converts the parallel video signal RGB to the serial video signal RGB. The I/O buffer F2 outputs the serial video signal RGB transmitted from the data stream converter 641. The memory control unit 643 transmits signals to the memory 616 or receives signals from the memory 616. The display panel module 618 comprises a pixel array which comprises m*n pixels, each pixel has the same structure as the pixel 700, and m and n are positive integers. The backlight module 620 comprises a plurality of red LEDs, a plurality of green LEDs, and a plurality of blue LEDs. The field sequence controller 614 further comprises a timing control unit 623 and a backlight module control unit 626. The backlight module control unit 626 is electrically connected to the plurality of the red LEDs, the plurality of the green LEDs, and the plurality of the blue LEDs, of the backlight module 620, for turning on/off the plurality of the red LEDs, the plurality of the green LEDs, and the plurality of the blue LEDs. The I/O buffer F2 outputs the serial video signal RGB from the data stream converter 641 to the display panel module 618, and outputs the field sequence driving signal to the backlight module 620. When the I/O buffer F2 outputs the field sequence driving signal to the backlight module 620, the backlight module control unit 626 of the field sequence controller 614 controls the backlight module 620 in the meantime, so as to turn on the LEDs of the color corresponding to the displayed color indicated from the field sequence driving signal.

FIG. 7 is a circuit diagram illustrating a pixel 700 of the display panel module 618 of the FSD 600 of the present invention. The pixel 700 comprises a pixel control switch 701, a black insertion control switch 703, a liquid crystal capacitor 707, and a storage capacitor 705. Both of the pixel control switch 701 and the black insertion control switch 703 comprise a gate, a drain, and a source. The timing control unit 623 is electrically connected to the gate of the pixel control switch 701 through a gate signal line, and is electrically connected to the gate of the black insertion control switch 703 through a black insertion gate signal line, for turning on/off the pixel control switch 701 and the black insertion control switch 703, respectively. The I/O buffer F2 is electrically connected to the source of the pixel control switch 701 through a data signal line, for transmitting data signal to the corresponding pixel. In other words, the I/O buffer F2 outputs the serial video signal RGB from the data stream converter 641 to the display panel module 618 by outputting the serial video signal RGB to the source of each pixel control switch through the corresponding data signal line. The liquid crystal capacitor 707 and the storage capacitor 705 are electrically connected between the drains of the pixel control switch 701 and the black insertion control switch 703, and a common end VCOM which provides a common voltage VCOM.

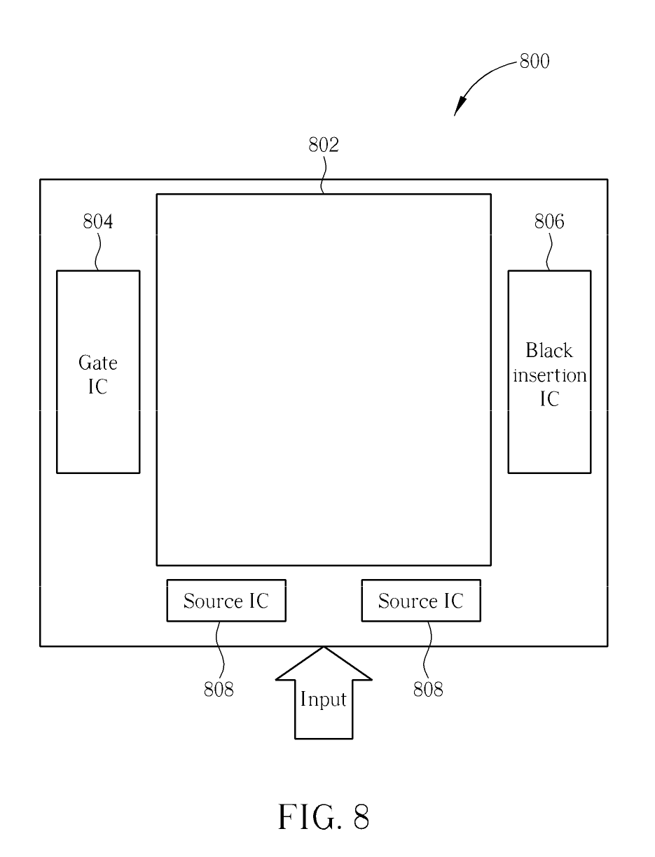

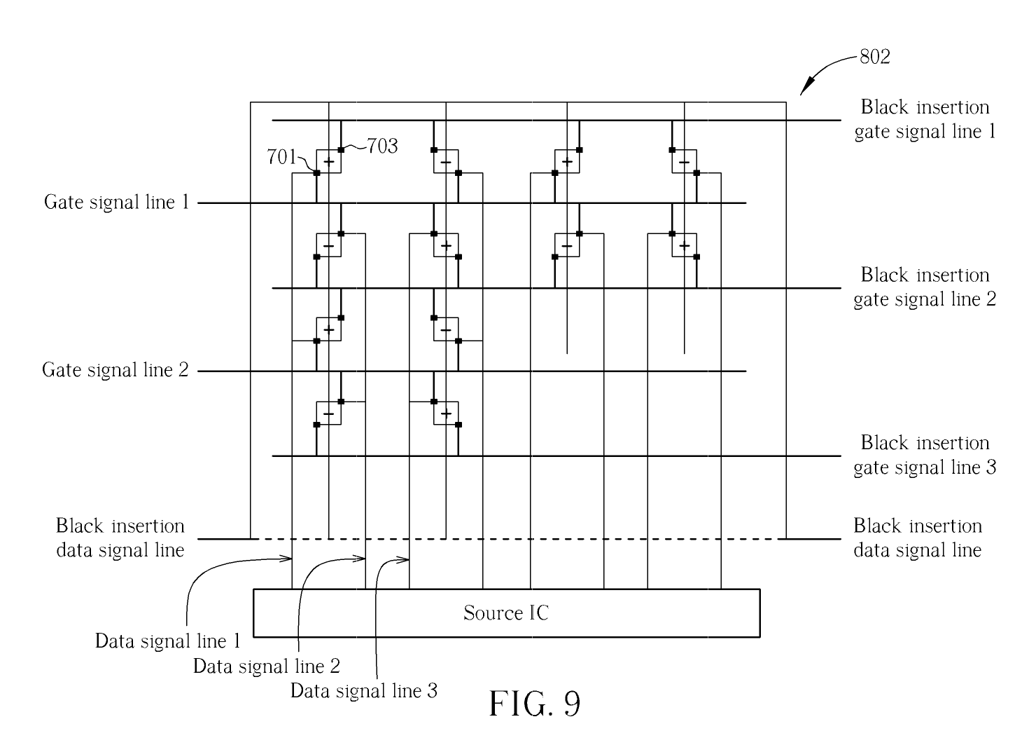

As for the display panel module 618 of the FSD with overlapped multi-scan driving of the present invention, the present invention discloses an embodiment for a display panel module with overlapped multi-scan driving by dot inversion to arrange the pixels. Please refer to FIG. 8 and FIG. 9. FIG. 8 is a block diagram illustrating a display panel module 800 with overlapped multi-scan driving by dot inversion according to the present invention. FIG. 9 is diagram illustrating the wire layout of the display panel 802 of the display panel module 800 according to the present invention. As shown in FIG. 8, the display panel module 800 comprises a display panel 802, a black insertion gate Integrated Chip (IC) 806, a gate IC 804, and a source IC 808. The source IC 808 is disposed at the bottom of the display panel 802, the black insertion gate IC 806 is disposed at one side of the display panel 802, and the gate IC 804 is disposed at the other side of the display panel 802. As shown in FIG. 9, the m*n pixels in the pixel array of the display panel 802 are arranged by dot inversion (the polarity of one pixel is inverted to the polarity of the corresponding adjacent pixel), and such arrangement reduces flicker. The p^{th} gate signal line is electrically connected to the gates of the pixel control switches disposed at the (2p−1)^{th} row and the (2p)^{th} row. For example, the 1^{st} gate signal line is electrically connected to the gates of the pixel control switches disposed at the 1^{st} row and the 2^{nd} row; the 2^{nd} gate signal line is electrically connected to the gates of the pixel control switches disposed at the 3^{rd} row and the 4^{th} row. The q^{th} black insertion gate signal line is electrically connected to the gates of the black insertion control switches disposed at the (2q−1)^{th} row and the (2q−2)^{th} row. For example, the 1^{st} black insertion gate signal line is electrically connected to the gates of the black insertion control switches disposed at the 1^{st} row; the 2^{nd} black insertion gate signal line is electrically connected to the gates of the black insertion control switches disposed at the 2^{nd} row and the 3^{rd} row. The sources of the pixel control switches disposed at odd rows and the (2r−1)^{th} column are connected to the (4r−3)^{th} data signal line. For example, the sources of the pixel control switches disposed at odd rows and the 1^{st} column are electrically connected to the 1^{st} data signal line; the sources of the pixel control switches disposed at odd rows and the 3^{rd} column are electrically connected to the 5^{th} data signal line. The sources of the pixel control switches disposed at even rows and the (2r−1)^{th} column are connected to the (4r−2)^{th} data signal line. For example, the sources of the pixel control switches disposed at even rows and the 1^{st} column are electrically connected to the 2^{nd} data signal line; the sources of the pixel control switches disposed at even rows and the 3^{rd} column are electrically connected to the 6^{th} data signal line. The sources of the pixel control switches disposed at odd rows and the (2r)^{th} column are connected to the (4r)^{th} data signal line. For example, the sources of the pixel control switches disposed at odd rows and the 2^{nd} column are electrically connected to the 4^{th} data signal line; the sources of the pixel control switches disposed at odd rows and the 4^{th} column are electrically connected to the 8th data signal line. The sources of the pixel control switches disposed at even rows and the (2r)^{th} column are connected to the (4r−1)^{th} data signal line. For example, the sources of the pixel control switches disposed at even rows and the 2^{nd} column are electrically connected to the 3^{rd} data signal line; the sources of the pixel control switches disposed at even rows and the 4^{th} column are electrically connected to the 7^{th} data signal line. The above-mentioned m, n, p, q, r are all positive integers. The sources of all black insertion control switches are electrically connected to one black insertion data signal line for receiving a black insertion voltage level. The black insertion gate signal lines are electrically connected to the black insertion gate IC 806, the gate signal lines are electrically connected to the gate IC 804, and the data signal lines are electrically connected to the source IC 808.

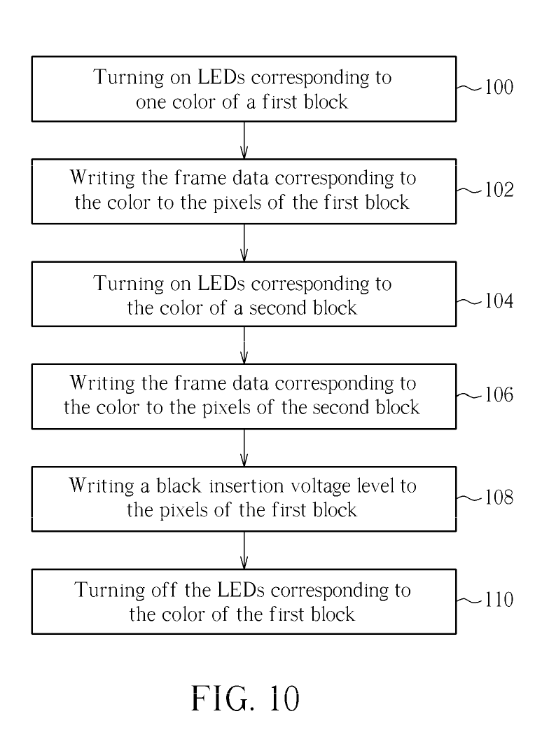

Please refer to FIG. 10. FIG. 10 is a flowchart illustrating a display method according to an embodiment of the FSD with overlapped multi-scan driving of the present invention. The steps are described as follows:

Step 100: turning on LEDs corresponding to one color of a first block of the plurality blocks of the backlight module 620;

Step 102: writing the frame data corresponding to the color to the pixels of the first block when the LEDs corresponding to the color of the first block are turned on;

Step 104: turning on LEDs corresponding to the color of a second block of the plurality blocks of the backlight module 620 after the frame data corresponding to the color to the pixels of the first block is written to the storage capacitors of the pixels of the first block, wherein the second block is adjacent to the first block;

Step 106: writing the frame data corresponding to the color to the pixels of the second block when the LEDs corresponding to the color of the second block;

Step 108: writing a black insertion voltage level to the pixels of the first block after the frame data corresponding to the color is written to the liquid crystal capacitors of the pixels of the first block;

Step 110: turning off the LEDs corresponding to the color of the first block after the black insertion voltage level is written to the pixels of the first block.

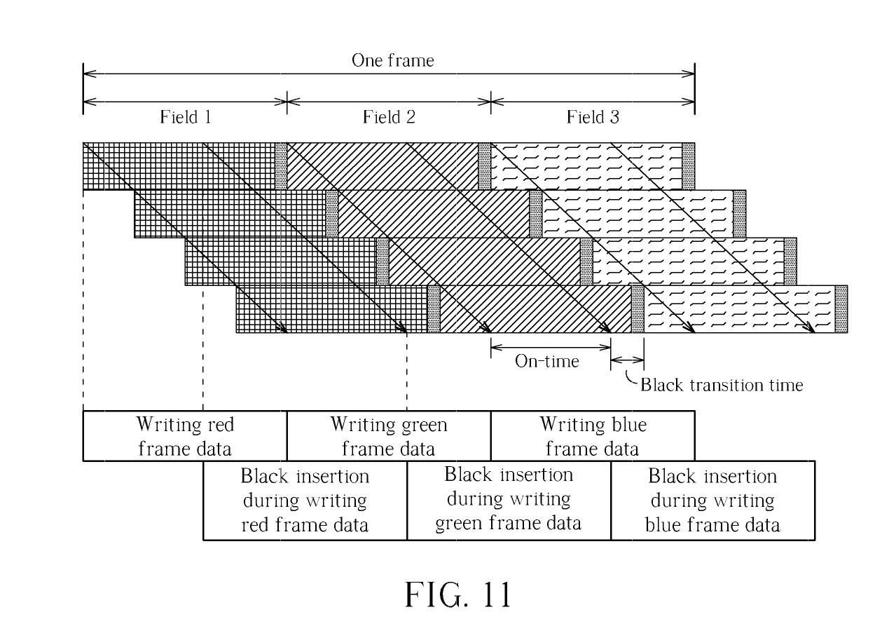

Please refer to FIG. 11. FIG. 11 is a diagram illustrating the driving principles of the FSD with overlapped multi-scan driving according to the present invention. As shown in FIG. 11, the LEDs of the backlight module 620 are divided into four blocks: a first, a second, a third, and a fourth blocks. The first block is disposed at the area ranged from the 1^{st} scan line to the i^{th} scan line of the display panel module 800; the second block is disposed at the area ranged from the (i+1)^{th} scan line to the (2i)^{th} scan line of the display panel module 800; the third block is disposed at the area ranged from the (2i+1)^{th} scan line to the (3i)^{th} scan line of the display panel module 800; the fourth block is disposed at the area ranged from the (3i+1)^{th} scan line to the (4i)^{th} scan line of the display panel module 800; wherein i is an integer, and m=4*i. The LEDs of the blocks for one color are sequentially turned on every interval, wherein the on-time of the LEDs of one block for that color overlaps with the on-time of the LEDs of another block, adjacent to that block, for that color. For example, the red LEDs of the 1^{st} block of the four blocks of the backlight module 620 are turned on (step 100), and when the red LEDs of the 1^{st} block are turned on, the frame data for red color is written to the pixels of the first block (step 102); after the frame data for the red color is written to the storage capacitors of the pixels of the 1^{st} block, the red LEDs of the 2^{nd} block are turned on (step 104), and when the red LEDs of the 2^{nd} block are turned on, the frame data for red color is written to the pixels of the first block (step 106); after the frame data for the red color is written to the liquid crystal capacitors of the pixels of the 1^{st} block, a black insertion voltage level is written to the pixels of the 1^{st} block (step 108); after the black insertion voltage level is written to the pixels of the 1^{st} block, the red LEDs of the 1^{st} block are turned off (step 110). Similarly, after the frame data for the red color is written to the storage capacitors of the 2^{nd} block, the red LEDs of the 3^{rd} block of the backlight module 620 re turned on, and when the red LEDs of the 3^{rd} block are turned on, the frame data for the red color is written to the pixels of the 3^{rd} block; when the frame data for the red color is written to the liquid crystal capacitors of the pixels of the 2^{nd} blocks, the black insertion voltage level is written to the pixels of the 2^{nd} block; when the black insertion voltage level is written to the pixels of the 2^{nd} block, the red LEDs of the 2^{nd} block are turned off. By such manner described above, the writing for the frame data for the red, the green, and the blue colors, and the black insertion voltage level are done, as shown in FIG. 11. It is noticeable that the turning-on for the red LEDs of the 2^{nd} block is executed before writing for the frame data for the red color to the liquid crystal capacitors of the pixels of the 1^{st} block finishes; similarly, the turning-on for the red LEDs of the 3^{rd} block is executed before writing for the frame data for the red color to the liquid crystal capacitors of the pixels of the 2^{nd} block finishes. By such manner, the frame data for the red, the green, and the blue colors are sequentially written to the four blocks.

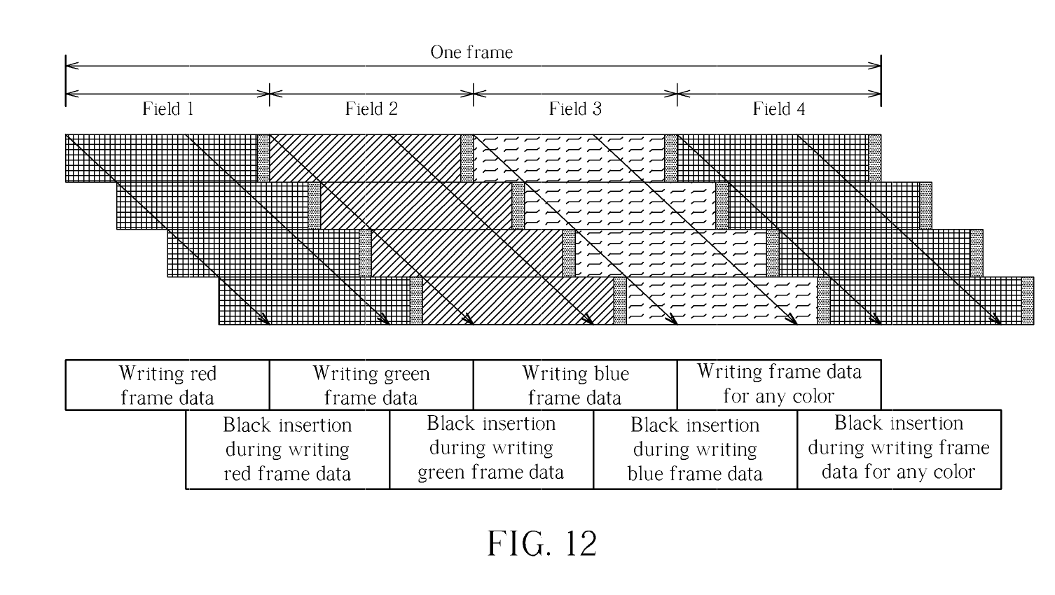

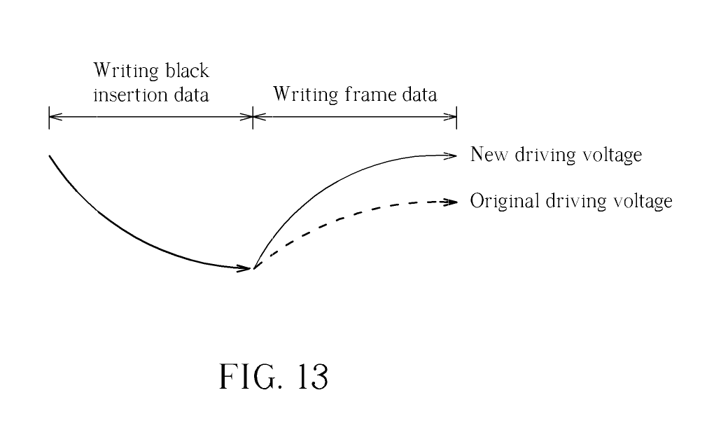

Since in the display method of FSD with overlapped multi-scan driving of the present invention, the response time of the liquid crystal and the on-times of the LEDs are as long as the scanning period of each scan line, the uneven color distribution and the color shift caused by the insufficient response time of the liquid crystal can be effectively solved, and the charging time can be increased. Therefore, the driving with turning on each of the red, the green, and the blue LEDs can be realized for one time (3 fields per frame) or more than one time, e.g. 4 fields per frame, as shown in FIG. 12. By utilizing turning on for 4 times in total for the red, the green, and the blue LEDs within one frame, insufficient displaying for one color of the frame can be solved. For example, by RGBG, or RGBR→GBRG→BRGB, the color separation can be further improved. Besides, since the black insertion voltage level for each frame is the same, every time when the frame data is written, liquid crystal reaches to the required grey level from the same level of the black insertion voltage level. Therefore, the gamma voltage is adjusted so that the response time of the liquid crystal is also adjusted. Please refer to FIG. 13. FIG. 13 is a diagram illustrating transition of the liquid crystal according to the FSD with overlapped multi-scan driving of the present invention. In FIG. 13, each liquid crystal reaches to the required grey level from the grey level of the same black insertion voltage level. Therefore, the response time of the liquid crystal can be increased with new driving voltages without looking up in the lookup table for finding out the new driving voltage corresponding to each pixel.

To sum up, the present invention provides FSD with overlapped multi-scan driving for eliminating the residual frame data from the previous frame, which not only solves the uneven color and the color shift, but also improves the color separation, and simplifies the steps of the gamma driving voltages, providing great convenience.

Those skilled in the art will readily observe that numerous modifications and alterations of the device and method may be made while retaining the teachings of the invention.

What is claimed is:

1. A Field Sequential Display (FSD) with overlapped multi-scan driving, comprising:
a Thin Film Transistor (TFT) Liquid Crystal Display (LCD) display panel module, comprising a pixel array, the pixel array comprising a plurality of pixels, each pixel comprising:
a pixel control switch, comprising a gate and a source; and
a black insertion control switch, comprising a gate;
a backlight module, comprising a plurality of red Light Emitting Diodes (LED), a plurality of green LEDs, and a plurality of blue LEDs; and
a field sequence controller, comprising:
a timing control unit, electrically connected to the gate of the pixel control switch through a gate signal line, and electrically connected to the gate of the black insertion control switch through a black insertion signal line, for turning on/off the pixel control switch and the black insertion control switch;
an Input/Output (I/O) buffer, electrically connected to the source of the pixel control switch through a data signal line, for transmitting data signals to the pixel; and
a backlight module control unit, electrically connected to the plurality of the red LEDs, the plurality of the green LEDs, and the plurality of the blue LEDs, for turning on/off the plurality of the red LEDs, the plurality of the green LEDs, and the plurality of the blue LEDs.

2. The FSD of claim 1, wherein the black insertion control switch further comprises a source for receiving a black insertion voltage level.

3. The FSD of claim 2, wherein the sources of the plurality of the black insertion control switches are electrically connected to each other.

4. The FSD of claim 1, wherein the pixel control switch further comprises a drain, electrically connected to a liquid crystal capacitor and a storage capacitor of the pixel.

5. The FSD of claim 1, wherein the black insertion control switch further comprising a drain, electrically connected to a liquid crystal capacitor and a storage capacitor of the pixel.

6. The FSD of claim 1, wherein the pixel array arranges the plurality of the pixels with dot inversion.

7. The FSD of claim 6, wherein a p^{th} gate signal line is electrically connected to the pixels at a (2p−1)^{th} row and a (2p)^{th} row, and p is a positive integer.

8. The FSD of claim 6, wherein a q^{th} black insertion gate signal line is electrically connected to the pixels at a (2q−1)^{th} row and a (2q−2)^{th} row, and q is a positive integer.

9. The FSD of claim 6, wherein the pixels at a (2r−1)^{th} column and odd rows are electrically connected to a (4r−3)^{th} data signal line; the pixels at a (2r−1)th column and even rows are electrically connected to a (4r−2)^{th} data signal line; the pixels at a (2r)^{th} column and odd rows are electrically connected to a (4r)^{th} data signal line; the pixels at a (2r)^{th} column and even rows are electrically connected to a (4r−1)^{th} data signal line; r is a positive integer.

10. A display method for FSD with overlapped multi-scan driving, comprising:
turning on LEDs for one color of a first block of a plurality of blocks of a backlight module;
writing a first frame data for the color to pixels of the first block when the LEDs for the color of the first block are turned on;
turning on LEDs for the color of a second block of the plurality of the blocks after the first frame data for the color is written to storage capacitors of the pixels of the first block;
wherein the second block is adjacent to the first block;
writing a second frame data for the color to pixels of the second block when the LEDs for the color of the second block are turned on;
writing a black insertion voltage level to the pixels of the first block after the first frame data is written to liquid crystal capacitors of the pixels of the first block; and
turning off the LEDs for the color of the first block after the black insertion voltage level is written to the pixels of the first block.

11. The display method of claim 10, wherein turning on the LEDs for the color of the first block comprises turning the LEDs for red color, green color, or blue color of the first block.

12. The display method of claim 11, wherein turning on the LEDs for the color of the second block is executed before writing the first frame data to the liquid crystal capacitors of the pixels of the first block finishes.
